(19) United States
(12) Patent Application Publication
(10) Pub. No.: US 2007/0027994 A1
(43) Pub. Date: Feb. 1, 2007

(54) Data transmission system and data transmission terminal

(75) Inventors: Takahisa Arai, Asaka-shi (JP); Junji Hayashi, Tokyo (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/490,096

(22) Filed: Jul. 21, 2006

(30) Foreign Application Priority Data
Jul. 26, 2005 (JP) 2005-215865

(51) Int. Cl. G06F 15/16

(52) U.S. Cl. 709/227

(57) ABSTRACT

A data transmission system, comprising a terminal to which data is input including a storage device in which the input data is recorded and a server to which the data stored in the storage device is collectively transmitted from the terminal according to a transmission instruction, wherein the server comprises a reception completion notice transmitting device for transmitting a reception completion notice to the terminal when the data collectively transmitted from the terminal is completely received, and the terminal comprises a deleting device for completely deleting the data recorded in the storage device when the reception completion notice is received from the server after transmitting the data recorded in the storage device to the server.

### BACKGROUND OF THE INVENTION

1. Field of the Invention

The present invention relates to a data transmission system and a data transmission terminal, and more particularly to a data transmission system and a data transmission terminal in which a print order for image data is received at the terminal and data on the print order is transmitted to a server.

2. Description of the Related Art

Digital cameras that record images as digital data have the advantage of allowing shot images to be previewed on the spot.

As a photograph sales system utilizing this advantage of the digital cameras, Japanese Patent Application Laid-Open No. 2003-223504 proposes a photograph sales system that allows participants in a group tour or the like to preview actual images before making a print order for the images. In this photograph sales system, images shot with digital cameras are read into an order-receiving apparatus. The read images are displayed on an image display device provided on the order-receiving apparatus, so that print orders from the tour participants are received. A photograph distributor generates prints based on the print order data that has been input to the order-receiving apparatus, and delivers the prints to the ordering participants.

The above order-receiving apparatus is generally used repeatedly, and data once input will remain in the order-receiving apparatus unless the provider of the apparatus expressly deletes the data. Therefore, in cases such as when the provider forgets to delete the data, irrelevant people may be able to view the images and personal information may leak out.

The present invention has been made in view of such issues, and an object thereof is to provide a data transmission system and a data transmission terminal capable of preventing data leak.

### SUMMARY OF THE INVENTION

To achieve the above object, a first aspect of the present invention provides a data transmission system, comprising a terminal to which data is input including a storage device in which the input data is recorded and a server to which the data stored in the storage device is collectively transmitted from the terminal according to a transmission instruction, wherein the server comprises a reception completion notice transmitting device for transmitting a reception completion notice to the terminal when the data collectively transmitted from the terminal is completely received, and the terminal comprises a deleting device for completely deleting the data recorded in the storage device when the reception completion notice is received from the server after transmitting the data recorded in the storage device to the server.

According to the first aspect of the present invention, when the terminal transmits the data to the server and the data is completely received at the server, the server transmits the reception completion notice to the terminal. When the reception completion notice is received at the terminal, the data recorded in the storage device is deleted. This may prevent forgetting to delete the transmitted data and may ensure prevention of data leak. This may also effectively prevent the same data from being recorded in both the terminal and the server and taking up much of the memory space of the terminal.

To achieve the above object, a second aspect of the present invention provides the data transmission system according to the first aspect, wherein the terminal further comprises a transmission completion notifying device for notifying of completion of transmission of the data when the reception completion notice is received from the server.

According to the second aspect of the present invention, in the first aspect of the present invention, the transmission completion notifying device notifies of completion of transmission of the data when the terminal receives the reception completion notice from the server.

To achieve the above object, a third aspect of the present invention provides the data transmission system according to the first or second aspect, wherein the terminal further comprises: an image data input device for inputting image data; and a print order data input device for inputting print order data for the image data that is input from the image data input device, and wherein the image data that is input from the image data input device and the print order data that is input from the print order data input device are stored in the storage device.

According to the third aspect of the present invention, data including the image data and the print order data is input to the terminal and stored in the storage device. Therefore, the image data and the print order data are transmitted from the terminal to the server.

To achieve the above object, a fourth aspect of the present invention provides the data transmission system according to the second aspect, wherein the terminal further comprises a display device for displaying the data that is input from the image data input device.

According to the fourth aspect of the present invention, the terminal is provided with the display device, on which images that are input from the image data input device are displayed. This may facilitate making a print order.

To achieve the above object, a fifth aspect of the present invention provides a data transmission terminal that records input data in a storage device and collectively transmits the data recorded in the storage device to a server according to a transmission instruction, the terminal comprising a deleting device for completely deleting the data recorded in the storage device when a reception completion notice transmitted from the server is received after transmitting the data recorded in the storage device to the server.

According to the fifth aspect of the present invention, when the reception completion notice is received from the server after the data is transmitted to the server, the data recorded in the storage device is deleted. This may prevent forgetting to delete the transmitted data and may ensure prevention of data leak. This may also effectively prevent the same data from being recorded in both the terminal and the server and taking up much of the memory space of the terminal.

To achieve the above object, a sixth aspect of the present invention provides the data transmission terminal according to the fifth aspect, further comprising: a transmission completion notifying device for notifying of completion of transmission of the data when the reception completion notice is received from the server.

According to the sixth aspect of the present invention, in the fifth aspect of the present invention, the transmission completion notifying device notifies of completion of transmission of the data when the terminal receives the reception completion notice from the server.

To achieve the above object, a seventh aspect of the present invention provides the data transmission terminal according to the fifth or sixth aspect, further comprising: an image data input device for inputting image data; and a print order data input device for inputting print order data for the image data that is input from the image data input device, wherein the image data that is input from the image data input device and the print order data that is input from the print order data input device are stored in the storage device.

According to the seventh aspect of the present invention, data including the image data and the print order data is input and stored in the storage device. Therefore, the image data and the print order data are transmitted from the terminal to the server.

To achieve the above object, an eighth aspect of the present invention provides the data transmission terminal according to the seventh aspect, wherein the terminal further comprises a display device for displaying the data that is input from the image data input device.

According to the eighth aspect of the present invention, images that are input from the image data input device are displayed on the display device. This may facilitate making a print order.

The data transmission system and the data transmission terminal according to the present invention may prevent data leak. In addition, they may effectively prevent the same data from being recorded in both the terminal and the server and taking up much of the memory space of the terminal.

### BRIEF DESCRIPTION OF THE DRAWINGS

FIG. 1 is a system configuration diagram of a print order system to which the present invention is applied;

FIG. 2 is a perspective view showing an external appearance of an order-receiving terminal;

FIG. 3 is a block diagram showing the electrical configuration of the order-receiving terminal and of a server;

FIGS. 4A and 4B are diagrams showing exemplary display on a monitor of the order-receiving terminal;

FIG. 5 is a flowchart showing a processing procedure for the order-receiving terminal;

FIGS. 6A and 6B are diagrams showing exemplary display on the monitor of the order-receiving terminal;

FIG. 7 is a flowchart showing a processing procedure for the server; and

FIG. 8 is a diagram showing exemplary display on the monitor of the order-receiving terminal.

### DETAILED DESCRIPTION OF THE PREFERRED EMBODIMENTS

Referring to the appended drawings, the best mode for implementing a data transmission system and a data transmission terminal according to the present invention will be described in detail below.

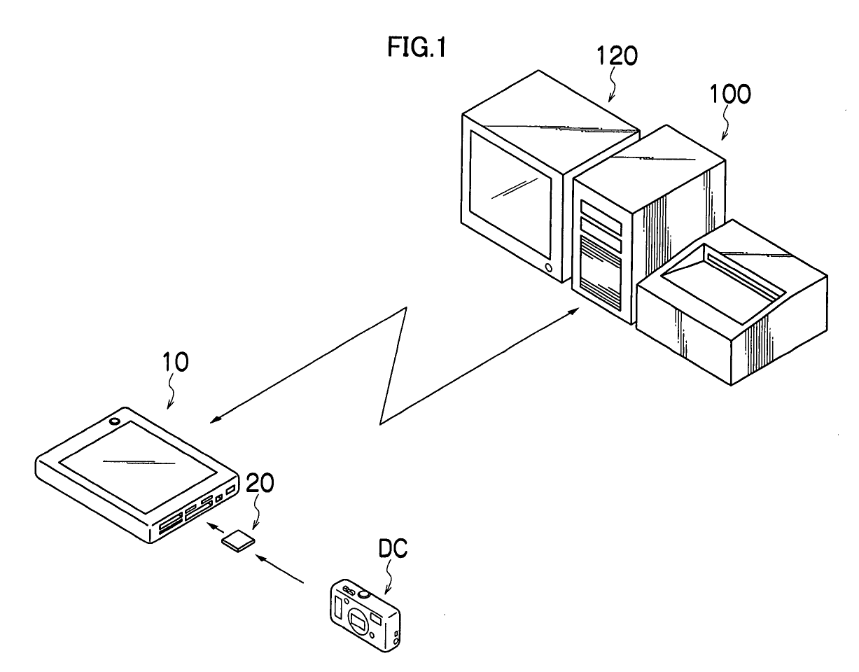

FIG. 1 is a system configuration diagram of a print order system to which the present invention is applied. The print order system 1 in this embodiment is implemented as a system used by, for example, participants in a group tour to make print orders on the spot for images they shot with digital cameras during the tour. The system consists of an order-receiving terminal 10 that receives print orders and a server 100. The tour participants input images they shot with their own digital cameras DC to the order-receiving terminal 10 and make print orders. The provider of the order-receiving terminal 10 (which is assumed to be a photograph distributor in this example), having received the orders from all participants, transmits data on the received orders (image data and print order data) to the server 100. The server 100 generates prints based on the received data on the received orders.

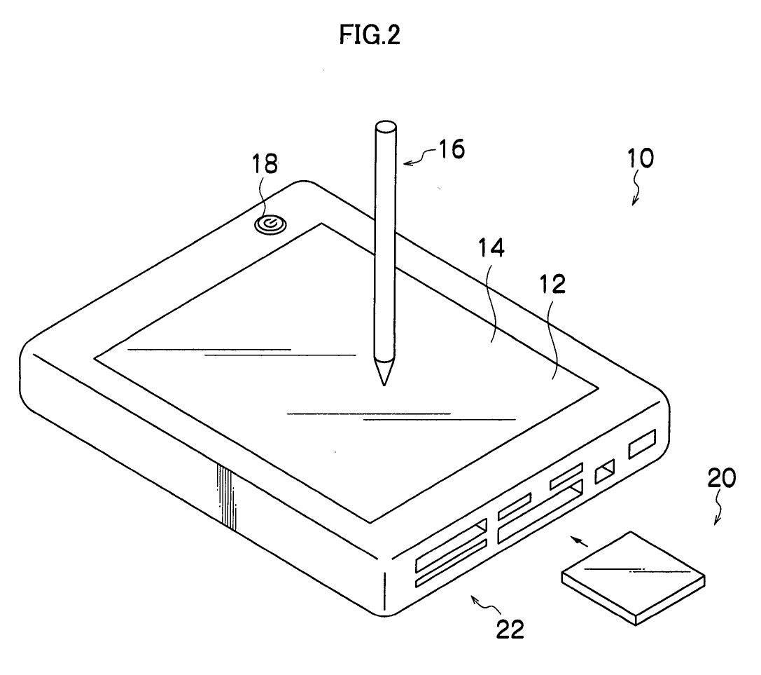

FIG. 2 is a perspective view showing an external appearance of the order-receiving terminal. As shown, the order-receiving terminal 10 is formed as a rectangular board with a monitor 12 provided on its upper surface. The monitor 12 is implemented as a color liquid crystal monitor, for example, and has a touch panel 14 provided on its surface. A user touches the screen of the monitor 12 with a stylus 16 according to the display on the monitor 12 to thereby input necessary information.

Also provided on the upper surface of the order-receiving terminal 10 is a power switch 18, which is operated to turn the power of the order-receiving terminal 10 on/off.

Memory card slots 22 for inserting various types of memory cards 20 are provided on a side of the order-receiving terminal 10. Image data to be printed is read by inserting the memory cards 20 into the memory card slots 22.

The server 100 is implemented as a general computer with a monitor and a printer.

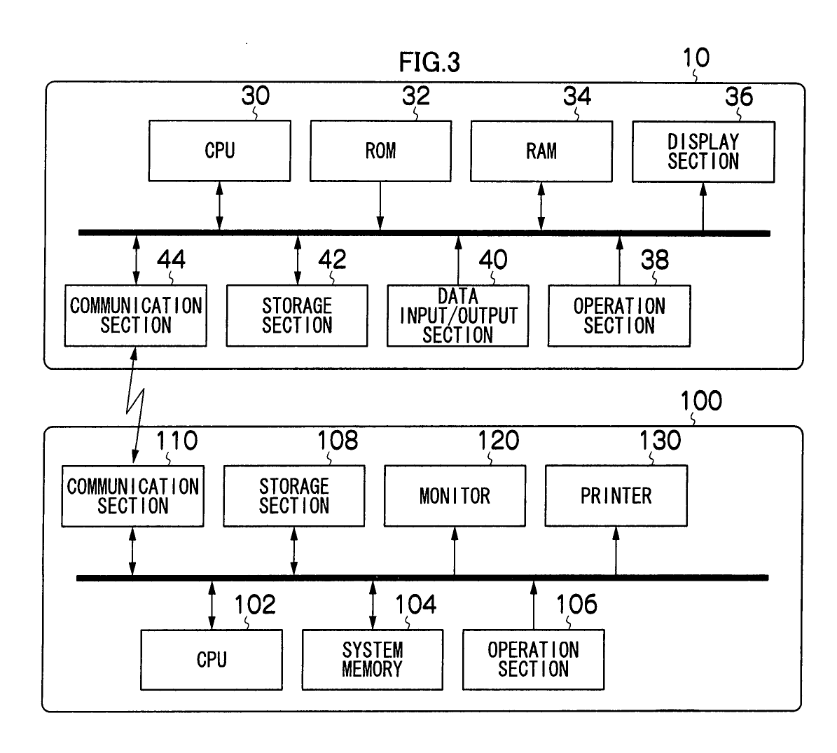

FIG. 3 is a block diagram showing the electrical configuration of the order-receiving terminal and the server.

First, the electrical configuration of the order-receiving terminal 10 will be described. As shown in FIG. 3, the order-receiving terminal 10 includes a CPU 30, a ROM 32, a RAM 34, a display section 36, an operation section 38, a data input/output section 40, a storage section 42, a communication section 44, and so forth.

The order-receiving terminal 10 has its overall operations centrally controlled by the CPU 30. Based on input from the operation section 38, the CPU 30 controls the components of the order-receiving terminal 10 according to predetermined control programs. The control programs to be executed by the CPU 30, as well as various types of data required for the control are recorded in the ROM 32. The RAM 34 is used as a working area for the CPU 30.

The display section 36 includes the above-mentioned monitor 12, and displays certain information on the monitor 12 according to instructions from the CPU 30.

The operation section 38 includes the above-mentioned touch panel 14 and power switch 18, and outputs their operation information to the CPU 30.

The data input/output section 40 includes the above-mentioned memory card slots 22, and reads data from and writes data to the memory cards 20 inserted into the respective memory card slots 22.

The storage section 42 is implemented as a hard disk drive (HDD), in which data such as image data that is input from the data input/output section 40 and print order data that is input from the operation section 38 is stored.

The communication section 44 transmits data to and receives data from the server 100 according to instructions from the CPU 30. It is assumed here that the communication with the server 100 is performed over a wireless LAN.

Next, the electrical configuration of the server 100 will be described. As shown in FIG. 3, the server 100 includes a CPU 102, a system memory 104, an operation section 106, a storage section 108, a communication section 110, a monitor 120, a printer 130, and so forth.

The server 100 has its overall operations centrally controlled by the CPU 102. Based on input from the operation section 106, the CPU 102 controls the components of the server 100 according to predetermined control programs.

The system memory 104 includes ROM and RAM. The system memory 104 is used as a working area for the CPU 102, and data required for various types of control is stored therein.

The operation section 106 includes a keyboard and a mouse, and outputs user operation information to the CPU 102.

The storage section 108 is implemented as a hard disk drive (HDD), in which an OS, as well as an application program for generating the print data, a communication program, the order data received from the order-receiving terminal 10, and so forth are stored.

The communication section 110 transmits data to and receives data from the order-receiving terminal 10 according to instructions from the CPU 102.

The monitor 120 is implemented as a color liquid crystal monitor, for example, and displays certain information according to instructions from the CPU 102.

The printer 130 prints the print data on certain printing paper according to instructions from the CPU 102. For example, an ink-jet printer, a thermal printer, or a laser printer is used as the printer 130.

Now, processing by the print order system 1 in this embodiment configured as described above will be described, starting at making a print order and ending at generating prints.

The description below will be given for an example in which an organizer of a group tour (or a photograph distributor) collectively receives image print orders from participants in the group tour. In this case, the organizer receives the print orders by passing around one (or more, depending on the number of the tour participants) order-receiving terminal 10 among the tour participants.

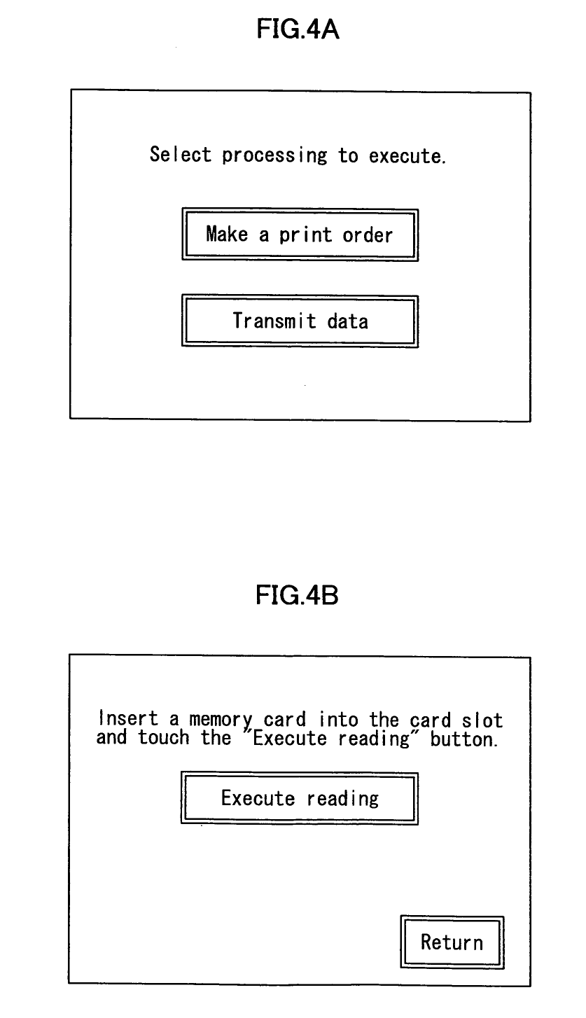

First, a first tour participant is provided with the order-receiving terminal 10 to make a print order. FIG. 4A shows a menu screen displayed on the monitor 12 of the order-receiving terminal 10. As shown, processing may be selected between “Make a print order” and “Transmit data.” To make a print order, the button “Make a print order” may be touched. Then, print order processing is performed in the order-receiving terminal 10.

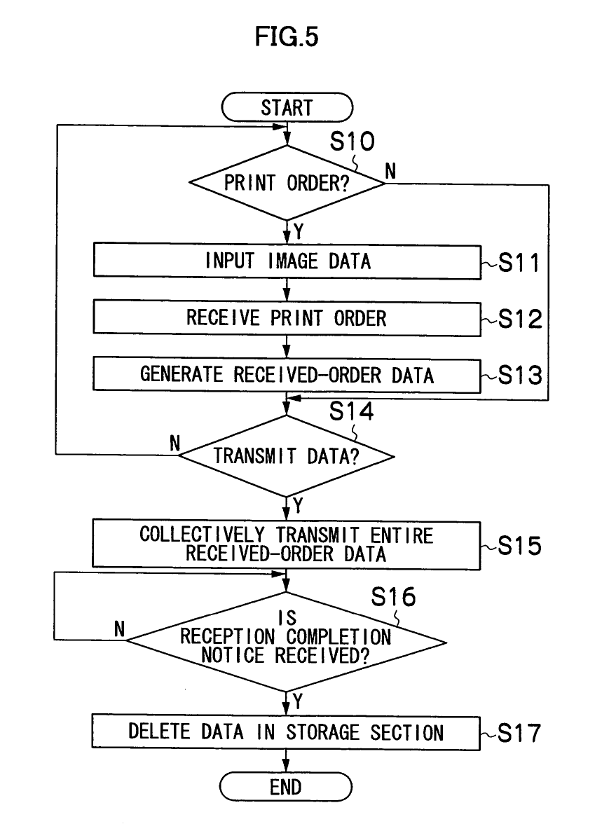

FIG. 5 is a flowchart showing a processing procedure for the order-receiving terminal 10. The CPU 30 of the order-receiving terminal 10 determines whether or not the print order processing is selected based on input from the touch panel 14 (step S10). If it is determined that the print order processing is selected, image data input processing is performed (step S11). The image data is input from a memory card slot 22. The participant inserts a memory card 20 that stores image data to be printed into the memory card slot 22 and instructs reading of the image data.

The instruction of reading the image data is given on the touch panel 14. The participant input an image reading instruction according to a predetermined guide displayed on the monitor 12. FIG. 4B shows exemplary display of the image reading instruction screen, which is displayed on the monitor 12 when the processing “Make a print order” is selected on the menu screen. The participant touches the button “Execute reading” displayed on the screen to instruct reading of the image data from the memory card 20.

When the execution of reading is instructed through the touch panel 14 in this manner, the CPU 30 of the order-receiving terminal 10 reads the image data from the memory card 20 and stores the read image data in the storage section 42.

Once the entire image data in the memory card is read into the storage section 42, the CPU 30 of the order-receiving terminal 10 starts print order receiving processing (step S12). The reception of a print order involves displaying the image data read into the storage section 42 on the monitor 12, and allowing necessary information to be input through the touch panel 14.

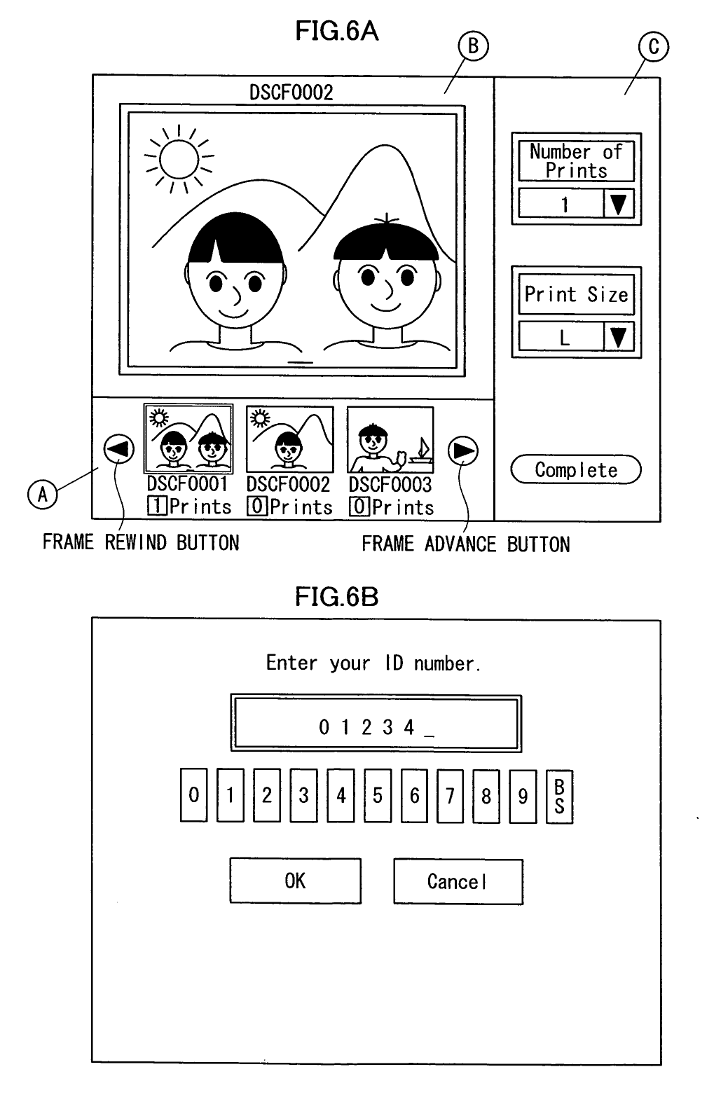

FIGS. 6A and 6B shows exemplary display on the monitor 12 of the order-receiving terminal 10 when a print order is made. As shown in FIG. 6A, the monitor screen consists of a thumbnail display area A, an enlarged display area B, and an order input area C. The thumbnail display area A displays reduced images (thumbnail images) of the images read from the memory card 20, and a selected one of the thumbnail images displayed in the thumbnail display area A is displayed in the enlarged display area B. Then, a print order is made in the order input area C for the image displayed in the enlarged display area B.

The print order area C has a Number of Prints field and a Print Size field. Desired number and size are entered into the Number of Prints field and the Print Size field to make a print order for the image displayed in the enlarged image display area B. Touching tabs displayed beside the respective fields with the stylus 16 causes display of pull-down lists of available numbers and sizes. A number and a size in the respective pull-down lists may be touched with the stylus 16 to enter the desired number of prints and print size.

Selecting among the thumbnail images displayed in the thumbnail display area A is performed by touching a thumbnail image displayed in the thumbnail display area A with the stylus 16.

Three images are displayed at a time in the thumbnail display area. Touching Frame Advance/Rewind buttons displayed at both sides with the stylus 16 causes frame-by-frame advance/rewind of the displayed images.

On completion of the print order input processing for desired images, the participant touches a “Complete” button provided in the print order area C and completes the print order input processing. Touching the “Complete” button causes the display on the monitor 12 to be shifted to an ID number input screen as shown in FIG. 6B. The participant enters an ID number according to the display on the monitor 12. The ID number is for identifying the orderer and assigned to each participant in advance. Instead of this processing, an address, name, phone number or the like may be entered.

Entering the ID number completes the print order processing of the first participant. The CPU 30 of the order-receiving terminal 10 generates data on the received order (image data to be printed, and print order data such as the number of prints and the size) based on the entered print order information (step S13). The CPU 30 switches the display of the monitor 12 to the menu screen shown in FIG. 4A.

Then, the CPU 30 of the order-receiving terminal 10 determines whether or not the “Transmit data” is selected on the menu screen based on input from the touch panel 14 (step S14). If it is determined that the data transmission is not selected, the processing returns to step S10, where it is determined whether or not the print order is selected. If it is determined that the print order is selected, the above-described print order processing is performed (steps S11 to S13).

In this manner, the tour organizer receives print orders from all tour participants and transmits the data on completion of receiving all print orders. That is, the data transmission is selected on the menu screen shown in FIG. 4A.

If the CPU 30 of the order-receiving terminal 10 determines that the data transmission is selected at the above step S14, it collectively transmits the entire received-order data stored in the storage section 42 to the server 100 (step S15). That is, the received-order data stored in the storage section 42 is transmitted to the communication section 110 of the server 100 via the communication section 44.

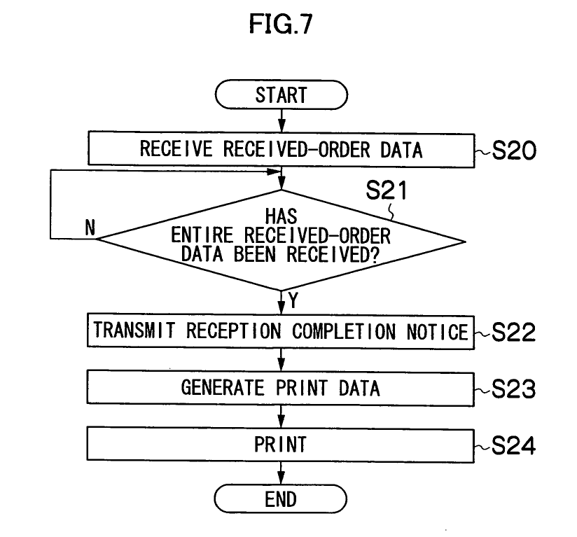

FIG. 7 is a flowchart showing a procedure of processing operations of the server 100 that has received the received-order data. As shown, when the received-order data begins to be received from the order-receiving terminal 10 (step S20), the CPU 102 of the server 100 determines whether or not the entire received-order data has been received (step S21). If it is determined that the entire received-order data has been received, a reception completion notice is transmitted to the order-receiving terminal 10 (step S22). Then, the server 100 generates print data based on the received-order data (step S23) and prints the specified numbers and sizes of images (step S24). The tour organizer delivers the generated prints to the orderers.

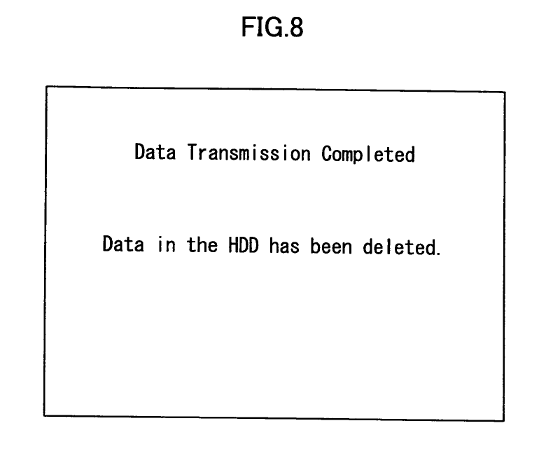

On the other hand, as shown in FIG. 5, after the CPU 30 of the order-receiving terminal 10 transmits the received-order data to the server 100, it determines whether or not the reception completion notice is received at the communication section 44 (step S16). If it is determined that the reception completion notice transmitted from the server 100 is received at the communication section 44, the entire data recorded in the storage section 42 is deleted (step S17). That is, data such as the image data and the order data that are input by the tour participants is completely deleted. As shown in FIG. 8, after the data is deleted, a message is displayed on the monitor 12 that the received-order data has been transmitted and the data has been deleted.

Thus, according to the print order system in this embodiment, the order-receiving terminal 10 receives the print orders and transmits the data on the received orders to the server 100, and then deletes the data in the storage device 42. Therefore, even if the order-receiving terminal 10 is used repeatedly, information leak does not occur. Deleting the data on the received orders after transmitting the data also allows efficient use of the storage section 42. Furthermore, this saves the effort to secure the space in the storage section 42 for the next use, thereby increasing the usability.

In this embodiment, after the data on the received orders is transmitted, the data in the storage section is not deleted until the reception completion notice is received from the server 100. However, the timing of deleting the data in the storage section is not limited to this. Rather, the data deletion may be at any time provided that the data can be deleted by the next use. For example, the data may be deleted immediately after being transmitted to the server 100, or may be deleted when a certain time has passed after being transmitted. Alternatively, the data may be deleted when a predetermined operation is performed. For example, the data may be deleted at the beginning of the next print order after being transmitted, or may be deleted on power-up for the next use. The data may also be deleted by inputting a password, or may be deleted by checking the images.

In this embodiment, the user is notified of the completion of data transmission and data deletion by the display on the monitor 12. However, a sound, light, vibration, and so forth may also be used for the notice.

In this embodiment, the memory card slot 22 is used as a device for inputting the image data to the order-receiving terminal 10. However, the device for inputting the image data to the order-receiving terminal 10 is not limited to it. For example, the order-receiving terminal 10 and a device such as a digital camera may be connected with each other via a communication cable (such as USB or IEEE 1394) so that the image data is directly input from the device such as a digital camera to the order-receiving terminal 10. Alternatively, a wireless communication medium, such as Bluetooth, infrared communication, or wireless LAN, may be used to input the image data from the device such as a digital camera to the order-receiving terminal 10. In addition, the operation device of the order-receiving terminal 10 is not limited to the touch panel but may be some other operation device, such as a keyboard.

The communication medium between the order-receiving terminal 10 and the server 100 is also not limited to a particular one but may be a wired communication medium, and it may be a communication medium using a public line or the Internet.

Although this embodiment employs the dedicated order-receiving terminal, it is possible to cause a notebook computer or PDA with a communication capability to execute a certain program so that the same functions as the above-described order-receiving terminal 10 are implemented.

In this embodiment, the server 100 is provided with the printer 130. However, the server 100 may only receive data and some other apparatus may perform generation of the print data and print processing.

The above embodiment has been described for the example in which the present invention is applied to the print order system. However, the application of the present invention is not limited to it. The present invention may be applied to any data transmission systems that involve inputting data to a terminal and transmitting the data to a server via the terminal.

What is claimed is:

1. A data transmission system, comprising:
a terminal to which data is input including a storage device in which the input data is recorded; and
a server to which the data stored in the storage device is collectively transmitted from the terminal according to a transmission instruction, wherein
the server comprises a reception completion notice transmitting device for transmitting a reception completion notice to the terminal when the data collectively transmitted from the terminal is completely received, and
the terminal comprises a deleting device for completely deleting the data recorded in the storage device when the reception completion notice is received from the server after transmitting the data recorded in the storage device to the server.

2. The data transmission system according to claim 1, wherein the terminal further comprises a transmission completion notifying device for notifying of completion of transmission of the data when the reception completion notice is received from the server.

3. The data transmission system according to claim 1, wherein the terminal further comprises:
an image data input device for inputting image data; and
a print order data input device for inputting print order data for the image data that is input from the image data input device, and wherein
the image data that is input from the image data input device and the print order data that is input from the print order data input device are stored in the storage device.

4. The data transmission system according to claim 2, wherein the terminal further comprises:
an image data input device for inputting image data; and
a print order data input device for inputting print order data for the image data that is input from the image data input device, and wherein
the image data that is input from the image data input device and the print order data that is input from the print order data input device are stored in the storage device.

5. The data transmission system according to claim 2, wherein the terminal further comprises a display device for displaying the data that is input from the image data input device.

6. A data transmission terminal that records input data in a storage device and collectively transmits the data recorded in the storage device to a server according to a transmission instruction, comprising:
a deleting device for completely deleting the data recorded in the storage device when a reception completion notice transmitted from the server is received after transmitting the data recorded in the storage device to the server.

7. The data transmission terminal according to claim 6, further comprising: a transmission completion notifying device for notifying of completion of transmission of the data when the reception completion notice is received from the server.

8. The data transmission terminal according to claim 6, further comprising:
an image data input device for inputting image data; and
a print order data input device for inputting print order data for the image data that is input from the image data input device, wherein
the image data that is input from the image data input device and the print order data that is input from the print order data input device are stored in the storage device.

9. The data transmission terminal according to claim 7, further comprising:
an image data input device for inputting image data; and
a print order data input device for inputting print order data for the image data that is input from the image data input device, wherein
the image data that is input from the image data input device and the print order data that is input from the print order data input device are stored in the storage device.

10. The data transmission terminal according to claim 8, further comprising: a display device for displaying the data that is input from the image data input device.
